(19) United States
(12) Patent Application Publication
(10) Pub. No.: US 2001/0049566 A1
(43) Pub. Date: Dec. 6, 2001

(54) Apparatus and method for controlling audio output in a mobile terminal

(75) Inventor: Jong-Kwang Kim, Kyongsangbuk-do (KR)

Correspondence Address: Paul J. Farrell, DILWORTH & BARRESE, LLP, 333 Earle Ovington Blvd., Uniondale, NY, 11553, US

(73) Assignee: Samsung Electronics Co., Ltd.

(21) Appl. No.: 09/851,451

(22) Filed: May 8, 2001

(30) Foreign Application Priority Data
May 12, 2000 (KR) 25317/2000
Apr. 6, 2001 (KR) 18414/2001

(51) Int. Cl. G06F 17/00

(52) U.S. Cl. 700/94

(57) ABSTRACT

An apparatus and method for properly controlling an audio gain of an MP3 player according to the type of an audio output device connected to a mobile terminal with the MP3 player for reproducing MP3-formatted audio data into an audio signal. An ear jack transfers the audio signal output from the MP3 player to one of first and second audio output devices, connected thereto, and generates a sense signal indicating a type of the connected audio output device. A controller determines the type of the audio output device connected to the ear jack depending on the sense signal and controls an audio gain of the MP3 player according to the determined result. The first audio output device is an earphone and the second audio output device is an external speaker. The controller increases the audio gain when the external speaker is connected to the ear jack, and the controller decreases the audio gain when the earphone is connected to the ear jack.

### PRIORITY

This application claims priority to an application entitled “Apparatus for Controlling Audio Output during Reproduction of Audio Data in a Mobile Telephone” filed in the Korean Industrial Property Office on May 12, 2000 and assigned Ser. No. 2000-25317; and an application entitled “Apparatus and Method for Controlling Audio Output in a Mobile Terminal” filed in the Korean Industrial Property Office on Apr. 6, 2001 and assigned Ser. No. 2001-18414, the contents of both of which are hereby incorporated by reference.

### BACKGROUND OF THE INVENTION

1. Field of the Invention

The present invention relates generally to a mobile terminal, and in particular, to an apparatus and method for controlling an audio output level in a mobile terminal with an MP3 (MPEG-1 Layer 3) player.

2. Description of the Related Art

In recent, a mobile terminal such as a mobile telephone tends to have a built-in MP3 player to allow the user to enjoy listening to music by reproducing MP3-formatted audio data. Such a mobile terminal with an MP3 player downloads the MP3-formatted audio data from an external device such as a personal computer (PC) and stores the downloaded audio data in a memory for the MP3 player. The stored audio data is reproduced into an audio signal by the MP3 player and the reproduced audio signal is output to an external audio output device (an earphone or an external speaker) through an ear jack of the mobile terminal. The user then listens to the audio signal through the earphone or the external speaker by connecting the corresponding audio output device to the ear jack of the mobile terminal. The user can adjust the volume of the audio signal using a volume control device.

Meanwhile, the type of the audio output device connected to the mobile terminal with the MP3 player varies according to circumstances, and conventionally, an audio gain of the MP3 player is independent of the type of the connected audio output device. Therefore, when the user connects the external speaker to the mobile terminal and runs the MP3 player in a Play (or reproduction) mode to listen to the music, the audio output level is too low for the user to enjoy the music. To solve this problem, the output level of the audio signal should be relatively higher when using the external speaker than when using the earphone.

### SUMMARY OF THE INVENTION

It is, therefore, an object of the present invention to provide an apparatus and method for properly controlling an audio gain of an MP3 player according to the type of an audio output device connected to a mobile terminal.

To achieve the above and other objects, there is provided an audio output control apparatus in a mobile terminal with an MP3 player for reproducing MP3-formatted audio data into an audio signal. An ear jack transfers the audio signal output from the MP3 player to one of first and second audio output devices, connected thereto, and generates a sense signal indicating a type of the connected audio output device. A controller determines the type of the audio output device connected to the ear jack depending on the sense signal and controls an audio gain of the MP3 player according to the determined result.

Preferably, the first audio output device is an earphone and the second audio output device is an external speaker. The controller increases the audio gain when the external speaker is connected to the ear jack, while the controller decreases the audio gain when the earphone is connected to the ear jack.

Preferably, the earphone includes a first ear jack connector connected to the ear jack, for generating the sense signal of a first level, and the external speaker includes a second ear jack connector connected to the ear jack, for generating the sense signal of a second level.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating an apparatus for controlling an audio output level in a mobile terminal with an MP3 player according to an embodiment of the present invention;

FIG. 2 is a circuit diagram illustrating the connection among an ear jack connector for an earphone, an ear jack connector for an external speaker and an ear jack, for sensing the type of an audio output device according to an embodiment of the present invention; and

FIG. 3 is a flow chart illustrating a method for controlling an audio output level in a mobile terminal with an MP3 player according to an embodiment of the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

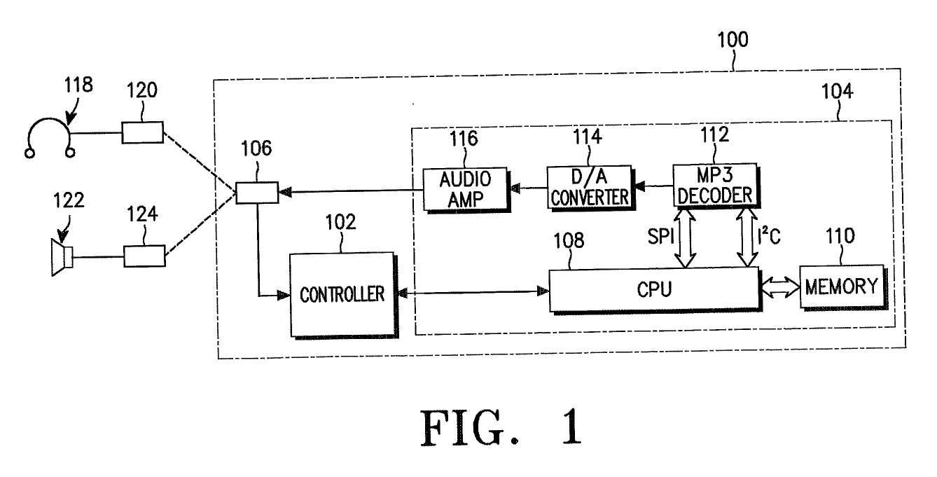

FIG. 1 illustrates a block diagram of an audio output control apparatus in a mobile terminal with an MP3 player according to an embodiment of the present invention. FIG. 1 shows a state in which an ear phone 118 or an external speaker 122 is connected to a common mobile terminal 100 having a controller 102, an MP3 player 104 and an ear jack 106. In FIG. 1, the elements of the mobile terminal 100, which are not connected directly with the present invention, are not shown for simplicity. Here, an ear jack connector 120 for the earphone 118 and an ear jack connector 124 for the external speaker 122, both in the form of a plug, are inserted in the ear jack 106 to optionally provide an audio signal output from the audio jack 106 to the earphone 118 or the external speaker 122.

The controller 102, a main controller, controls various functions of the mobile terminal 100. For example, assuming that the mobile terminal 100 is a mobile telephone, the controller 102 performs a call or data communication function, and provides a CPU (Central Processing Unit) 108 in the MP3 player 104 with key input data for Record, Play and Stop operations, received from a key input section (not shown). In addition, the controller 102 controls the MP3 player 104 so as to perform the audio output control function according to an embodiment of the present invention.

Now, a detailed description of the MP3 player 104 will be made with reference to FIG. 1. For the CPU 108, a microprocessor chip M66573 by OKI Company can be used. The CPU 108 downloads MP3-formatted audio data from an external device through the controller 102 and stores the downloaded audio data in a memory 110. Further, the CPU 108 reproduces the MP3-formatted audio data stored in the memory 110 using an MP3 decoder 112. The CPU 108 controls and monitors the MP3 decoder 112 through an I²C bus, and provides the audio data read from the memory 110 to the MP3 decoder 112 through a serial data interface SPI. In addition, the CPU 108 performs an operation associated with key input data for Record, Play and Stop functions, provided from the controller 102, and provides various operating status information to the controller 102. The memory 110, for which a flash memory is typically used, stores the MP3-formatted audio data. For the MP3 decoder 112, an MP3 decoder chip STA013 by STMicroelectronics Company is typically used. The MP3 decoder 112 reads the audio data compressed into an MP3 format from the memory 110 through the CPU 108 and decodes the read audio data into PCM (Pulse Code Modulation) data. The MP3 decoder 112 demultiplexes (or separates) control data and audio data from an 8-320 Kbps encoded input audio stream, performs Huffman decoding on the audio data to decode the signal compressed by run-length coding into its original-lengthened signal, and performs dequantization and rescaling for the respective sub-bands by controlling the control data. The MP3 decoder 112 restores the resulting data by inverse discrete cosine transform (IDCT), converts the restored audio data into stereo or mono PCM data by performing inverse filtering for the respective sub-bands, and provides the converted PCM data to a digital-to-analog (D/A) converter 114. For the D/A converter 114, a D/A converter chip CS4331 for stereo audio by Crystal Company is typically used. The D/A converter 114 includes digital interpolation, delta-sigma D/A conversion, digital de-emphasis and filtering circuits, and converts the PCM audio data output from the MP3 decoder 112 into an analog audio signal. An audio amplifier 116 amplifies the analog audio signal output from the D/A converter 114. The audio signal amplified by the audio amplifier 116 is provided to the earphone 118 or the external speaker 122 through the ear jack 106.

To the ear jack 106 is connected the earphone 118 or the external speaker 122, as an audio output device. The ear jack 106 generates a sense signal indicating the type of the audio output device connected thereto and provides the generated sense signal to the controller 102. If the MP3 player 104 initiates a Play (or reproducing) operation, the controller 102 determines the type of the audio output device connected to the ear jack 106 depending on the sense signal generated from the ear jack 106, and adjusts an audio gain of the MP3 player 104 according to the determined result, thereby controlling an audio output level of a signal output to the earphone 118 or the external speaker 122 through the ear jack 106. The audio gains associated with the types of the audio output devices are previously determined, so that the CPU 108 of the MP3 player 104 can control the audio gain of the MP3 decoder 112 under the control of the controller 102.

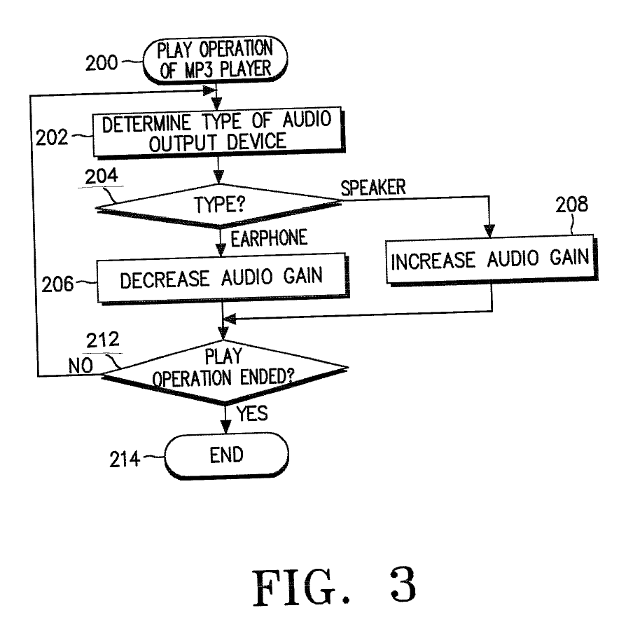

Now, with reference to FIG. 3, a detailed description will be made regarding how the controller 102 controls an audio output level according to an embodiment of the present invention. If the MP3 player 104 performs a Play operation in step 200, the controller 102 determines the type of the audio output device connected to the ear jack 106 depending on the sense signal generated from the ear jack 106 in steps 202-204. If it is determined that the earphone 118 is connected to the ear jack 106, the controller 102 controls the audio gain to be proper for the earphone 118 through the CPU 108 of the MP3 player 104, in step 206. In this case, the controller 102 relatively decreases the audio gain to be matched with an audio output characteristic of the earphone 118, as compared with the case where the external speaker 122 is connected to the ear jack 106. Otherwise, if it is determined that the external speaker 122 is connected to the ear jack 106, the controller 102 controls the audio gain to be proper for the external speaker 122 through the CPU 108 of the MP3 player 104, in step 208. In this case, the controller 102 relatively increases the audio gain to be matched with an audio output characteristic of the external speaker 122, as compared with the case where the earphone 118 is connected to the ear jack 106. Thereafter, the controller 102 determines in step 212 whether the Play operation is ended. If the Play operation is ended, the controller 102 stops the audio output control operation in step 214. Otherwise, if the Play operation is not ended, the controller 102 returns to step 202.

To sum up, the controller 102 determines the type of the audio output device connected to the mobile terminal 100 and automatically controls the audio gain of the MP3 player 104 to be proper for the earphone 118 or the external speaker 122 according to the determined result, thereby allowing the user to enjoy the audio signal at a proper audio output level.

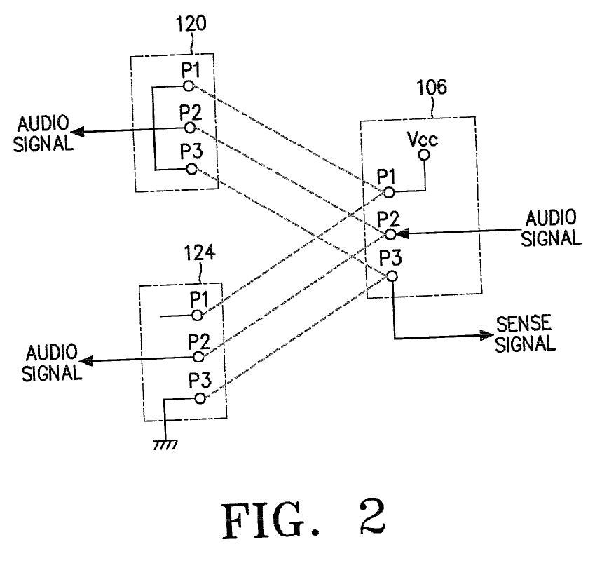

To this end, the controller 102 should be able to determine which audio output device (out of the earphone 118 and the external speaker 122) is connected to the ear jack 106. FIG. 2 is a circuit diagram illustrating the connection among the ear jack connector 120 for the earphone 118, the ear jack connector 124 for the external speaker 122, and the ear jack 106, for detecting the type of the audio output device. In FIG. 2, the ear jack connector 120 for the earphone 118, the ear jack connector 124 for the external speaker 122, and the ear jack 106 each have three nodes P1-P3, for simplicity. In practice, however, they have one more ground node, and in case of the stereo audio signal, further include another audio signal node P2′.

Referring to FIG. 2, in the ear jack 106, node PI is connected to a power supply voltage Vcc, node P2 is connected to an output end of the audio amplifier 116 in the MP3 player 104, and node P3 is connected to an input end of the controller 102. In the ear jack connector 120 for the earphone 118, node P1 is connected to node P3, and node P2 is connected to an audio signal input end of the earphone 118. In the ear jack connector 124 for the external speaker 122, node P1 is opened, node P2 is connected to an audio signal input end of the external speaker 122, and node P3 is grounded.

In operation, when the ear jack connector 120 for the earphone 118 is connected to the ear jack 106, a connection is made through node P1 of the ear jack 106 to node P1 of the ear jack connector 120 through to node P3 of the ear jack connector 120, and to node P3 of the ear jack 106, thus providing the sense signal of a ‘HIGH’ level to the controller 102. Otherwise, when the ear jack 124 for the external speaker 122 is connected to the ear jack 106, node P1 of the ear jack connector 124 is opened and node P3 of the ear jack connector 124 is grounded, thus providing the sense signal of a ‘LOW’ level to the controller 102. Therefore, upon detecting the sense signal of the ‘HIGH’ level, the controller 102 determines that the earphone 118 is connected to the mobile terminal 100. However, upon detecting the sense signal of the ‘LOW’ level, the controller 102 determines that the external speaker 122 is connected to the mobile terminal 100. In this method, the controller 102 can determine which audio output device is connected to the earjack 106.

As described above, the novel mobile terminal according to the present invention determines the type of the audio output device connected thereto and automatically controls the audio gain of the MP3 player according to the determined results, so that the user can enjoy the audio signal at a proper output level, no matter which audio output device is used.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An audio output control apparatus in a mobile terminal having an MP3 player for reproducing MP3-formatted audio data into an audio signal, comprising:
an ear jack for transferring the audio signal output from the MP3 player to one of a first and a second audio output device, connected thereto, and generating a sense signal indicating a type of the connected audio output device; and
a controller for determining the type of the audio output device connected to the ear jack depending on the sense signal and controlling an audio gain of the MP3 player according to the determined result.

2. The audio output control apparatus as claimed in claim 1, wherein the first audio output device is an earphone and the second audio output device is an external speaker.

3. The audio output control apparatus as claimed in claim 2, wherein the controller increases the audio gain when the external speaker is connected to the ear jack, and the controller decreases the audio gain when the earphone is connected to the ear jack.

4. The audio output control apparatus as claimed in claim 2, wherein the earphone includes a first ear jack connector connected to the ear jack for generating a sense signal of a first level, and the external speaker includes a second ear jack connector connected to the ear jack for generating a sense signal of a second level.

5. A method for controlling an audio gain of an MP3 player in a mobile terminal having the MP3 player for reproducing MP3-formatted audio data into an audio signal, the mobile terminal including an ear jack for generating a sense signal indicating a type of an audio output device connected thereto, the audio output device including an earphone and an external speaker, comprising the steps of:
determining the type of the audio output device connected to the ear jack during an operation of the MP3 player; and
controlling the audio gain of the MP3 player according to the determined type of the audio output device connected to the ear jack.

6. The method as claimed in claim 5, wherein the controlling step comprises the steps of:
increasing the audio gain when an external speaker is connected to the ear jack; and
decreasing the audio gain when an earphone is connected to the ear jack.
